(19) United States
(12) Patent Application Publication
(10) Pub. No.: US 2018/0331431 A1
(43) Pub. Date: Nov. 15, 2018

(54) CASSEGRAIN ANTENNA FOR EQUALIZING ORBITAL ANGULAR MOMENTUM MODE TRANMISSION LOSS

(71) Applicant: Electronics and Telecommunications Research Institute, Daejeon (KR)

(72) Inventor: Wang Joo LEE, Daejeon (KR)

(73) Assignee: Electronics and Telecommunications Research Institute, Daejeon (KR)

(21) Appl. No.: 15/978,426

(22) Filed: May 14, 2018

(30) Foreign Application Priority Data
May 15, 2017 (KR) 10-2017-0059802

(51) Int. Cl. H01Q 19/19

(52) U.S. Cl. CPC H01Q 19/191; H01Q 25/007

(57) ABSTRACT

Disclosed is a Cassegrain-type antenna. The Cassegrain-type antenna may comprise a main-reflector; a sub-reflector; and a radiator radiating beams by using a plurality of emitters. Also, a reflective surface of the sub-reflector has a shape of a trace formed by rotating a first curve having a vertex and being convex toward the main-reflector around a rotation axis spaced apart from the vertex.

### CROSS-REFERENCE TO RELATED APPLICATIONS

This application claims priority to Korean Patent Application No. 10-2017-0059802 filed on May 15, 2017 in the Korean Intellectual Property Office (KIPO), the entire contents of which are hereby incorporated by reference.

### BACKGROUND

### Technical Field

The present disclosure relates to an antenna, and more specifically, to an antenna capable of reducing differences in transmission losses between beams having different orbital angular momentum (OAM) modes.

### Related Art

As mobile communication devices are being spread, the number of Internet accesses through mobile devices surpassed the number of Internet accesses through personal computers, and most of the Internet accesses are currently being generated by the mobile devices. As the wireless communication environment is activated, the traffic volume of smart phones is steadily increasing. Accordingly, various technologies that can increase the communication capacity have been developed.

Time division multiplexing (TDM), frequency division multiplexing (FDM), and code division multiplexing (CDM) are used as multiplexing schemes for increasing the communication capacity. Also, a rotational mode multiplexing scheme based on Orbital Angular Momentum (OAM) modes has been recently studied to increase the communication capacity. The OAM is a physical property of a beam determined by a wavefront shape of a rotational mode beam (hereinafter referred to as a beam). A transmitting end may transmit different data through beams having different OAM modes, thereby increasing the amount of transmitted data. Also, a receiving end may selectively separate a beam having a specific OAM mode from a multiplexed beam to recover the data.

In the case of the conventional antenna, a divergence angle of a beam differs according to the OAM of the beam, so that reception intensities of the zeroth order OAM mode beam and higher order (e.g., 1^{st} order and 2^{nd} order) OAM mode beams may vary. There is a problem in that it is difficult to selectively detect a specific OAM component at the receiving end if the difference between the reception intensities of the beams according to the OAM modes exceeds a certain level. Also, even when the OAM component having a small reception intensity is detected at the receiving end, the signal to interference and noise ratio (SINR) is low, and thus it may be difficult to recover the data.

### SUMMARY

Accordingly, embodiments of the present disclosure provide an antenna and a signal transmission method using the antenna, which can reduce differences in transmission losses between beams having different OAM modes by controlling antenna gains of the beams according to the OAM modes of the beams.

In order to achieve the objective of the present disclosure, a Cassegrain-type antenna may comprise a main-reflector; a sub-reflector; and a radiator radiating beams by using a plurality of emitters, wherein a reflective surface of the sub-reflector has a shape of a trace formed by rotating a first curve having a vertex and being convex toward the main-reflector around a rotation axis spaced apart from the vertex.

The rotation axis may meet one end of the first curve.

The reflective surface of the sub-reflector may include vertexes forming a circular trace.

The reflective surface of the sub-reflector may further include a vertex formed in a direction opposite to a direction facing the main-reflector.

The reflective surface of the sub-reflector may have a shape of a trace formed by rotating at least a part of a hyperbola.

The focal points of the reflective surface of the sub-reflector may form a circular trace.

A reflective surface of the main-reflector may have a shape convex in a direction opposite to the direction facing the sub-reflector.

The reflective surface of the main-reflector may have a shape of a trace formed by rotating a second curve having a vertex around a rotation axis spaced apart from the vertex of the second curve.

The second curve may be convex in a direction opposite to the direction toward the sub-reflector.

The reflective surface of the main-reflector includes vertexes forming a circular trace.

The beams radiated by the radiator may be reflected by the sub-reflector, and then reflected by the main-reflector, and antenna gains of the beams reflected by the main-reflector may be changed according to respective orbital angular momentums (OAMs) of the beams.

The antenna gains of zeroth order OAM mode beams among the beams may become less than the antenna gains of 1^{st} order OAM mode beams among the beams.

Using to the embodiments according to the present disclosure, it is made possible to easily detect a beam having a specific OAM at the receiving end by reducing the differences of transmission losses or transmission gains between the zeroth order mode beam and the higher order mode beams. Also, by reducing the transmission loss of the higher order mode beams, the signal-to-noise ratio (SNR) of the higher order mode beams can be increased.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating a wavefront of a beam according to each OAM mode of the beam;

FIG. 2 is a conceptual diagram illustrating propagation shapes of beams having different OAMs;

FIG. 3 is a graph illustrating beam intensities at the cross-section of the beams M0, M1 and M2;

FIG. 4 is a perspective view of a conventional Cassegrain-type antenna radiating a rotational mode beam;

FIG. 5 is a conceptual diagram illustrating that the antenna shown in FIG. 4 emits zeroth order OAM mode beam rays;

FIG. 6 is a conceptual diagram illustrating that the antenna shown in FIG. 4 emits 1st order OAM mode beam rays;

FIG. 7 is a graph illustrating transmission losses according to OAM modes of beams emitted from the conventional antenna;

FIG. 8 is a perspective view of an antenna according to a first embodiment of the present disclosure;

FIG. 9 is a conceptual diagram illustrating a reflective surface shape of the sub-reflector shown in FIG. 8;

FIG. 10 is a graph illustrating an example of a hyperbola;

FIG. 11 is a perspective view showing a cross-section of the sub-reflector shown in FIG. 8;

FIG. 12 is a cross-sectional view of the antenna shown in FIG. 8;

FIG. 13 is a conceptual diagram illustrating traveling directions of beam rays when the radiator 110 emits the zeroth order mode beam;

FIG. 14 is a conceptual diagram illustrating traveling directions of beam rays when the radiator 110 emits the 1^{st} order mode beam;

FIG. 15 is a conceptual view illustrating a cross-section of an antenna and traveling directions of higher-order mode beam rays according to a second embodiment of the present disclosure;

FIG. 16 is a graph illustrating antenna gains when zeroth order mode beam is radiated using the conventional antenna shown in FIG. 4;

FIG. 17 is a graph illustrating antenna gains when 1^{st} order mode beams are radiated using the conventional antenna shown in FIG. 4;

FIG. 18 is a graph illustrating antenna gains when zeroth order mode beam is radiated using the antenna described referring to FIGS. 8 to 15;

FIG. 19 is a graph illustrating antenna gains when 1^{st} order mode beams are radiated using the antenna described referring to FIGS. 8 to 15; and

FIGS. 20A and 20B are diagrams illustrating results of comparison between electromagnetic field intensities of zeroth order and 1^{st} order mode beams radiated respectively from the conventional antenna and the antenna according to the embodiment of the present disclosure.

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings.

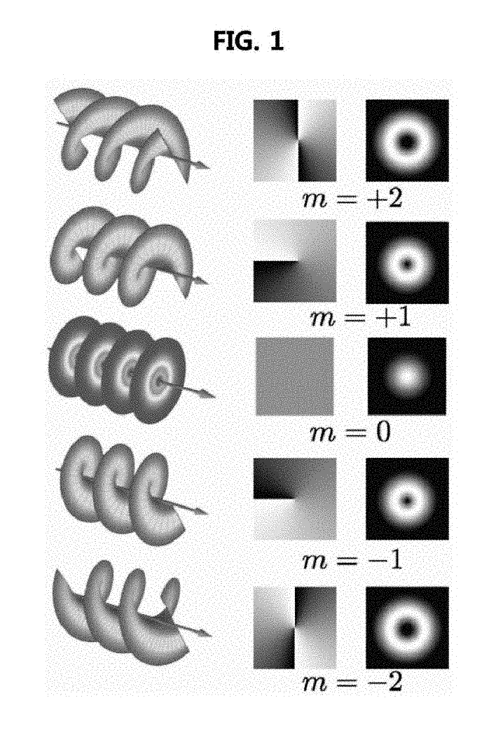

FIG. 1 is a conceptual diagram illustrating a wavefront of a beam according to each OAM mode of the beam.

Referring to FIG. 1, when the OAM of the beam is changed, the wavefront of the beam may also be changed. For example, in case of the zeroth order mode in which the OAM of the beam is zero, the wavefront of the beam may be a plane perpendicular to the traveling direction of the beam. That is, the phase of the beam may be the same in the cross-section of the beam. On the other hand, when the OAM of the beam is not zero, the wavefront of the beam may be a helical shape that rotates with respect to the traveling direction of the beam. The shape of the wavefront of the beam may be changed according to an integer value m representing the OAM mode of the beam. Also, the direction of rotation of the helical shape may be different depending on m. If the OAM mode of the beam is not zero, the phase of the beam may vary depending on a position in the cross-section of the beam.

In a communication network, the transmitting end can transmit data in an OAM-based multiplexing scheme by using beams having different OAMs. Also, the receiving end can recover the data by separating each OAM components from received beams. Accordingly, the communication capacity can be increased by the OAM-mode based multiplexing scheme.

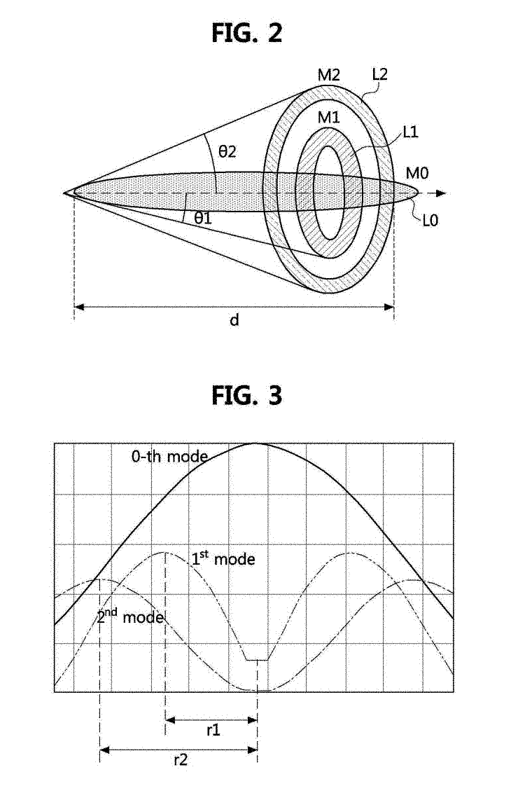

FIG. 2 is a conceptual diagram illustrating propagation shapes of beams having different OAMs. In FIG. 2, only regions L0, L1, and L2 where electromagnetic waves of the beams having relatively high intensity are illustrated as shaded, but electromagnetic waves may also exist in regions not illustrated in FIG. 2.

Referring to FIG. 2, a beam M0 having the zeroth order OAM mode may have a strongest intensity at the center of the cross-section of the beam. Therefore, the beam of the zeroth order OAM mode may have a smaller divergence angle than beams having higher order OAM modes. On the other hand, a beam M1 having the 1^{st} order OAM mode may have a relatively small intensity at the center of the cross-section of the beam and a large intensity in an annular shaped region L1. The radius of the annular shaped region L1 where the intensity of the beam is large can increase together as the traveling distance d of the beam M1 increases. That is, the divergence angle θ1 of the 1^{st} order OAM mode beam M1 may be larger than the divergence angle of the zeroth order OAM mode beam M0. Also, a beam M2 having the 2^{nd} order OAM mode may have a relatively small intensity at the center of the cross-section of the beam M2 and a large intensity at an annular shaped region L2. The radius of the annular shaped region L2 of the beam M2 may be greater than the radius of the annular shaped region L1 of the beam M1. There, the divergence angle θ2 of the 2^{nd} order OAM mode beam M2 may be greater than the divergence angle of the 1^{st} order OAM mode beam M1.

Since the divergence angle of the zeroth order OAM mode beam M0 is relatively small, even if the traveling distance d of the beam M0 increases, the degree of decrease in the reception intensity of the beam M0 at the receiving end may be small. On the other hand, since the divergence angles of the higher order OAM mode beams M1 and M2 are relatively larger than that of the zeroth order OAM mode beam M0, when the traveling distance d of the beams M1 and M2 increases, the degree of decrease in the reception intensities of the beams M1 and M2 at the receiving end may be large. For example, the divergence angle θ2 of the 2^{nd} order OAM mode beam M2 may be

$$\sqrt{3 \text{/} 2} = ( \sqrt{\frac{( order of M 2 ) + 1}{( order of M 1 ) + 1}} )$$

times larger than the divergence angle θ1 of the 1^{st} order OAM mode beam M1.

FIG. 3 is a graph illustrating beam intensities at the cross-section of the beams M0, M1 and M2.

Referring to FIG. 3, the intensity of the zeroth order OAM mode beam M0 may be the strongest at the center of the cross-section of the beam. The intensity of the beam M0 may become weaker as the distance from the center of the cross-section increases. The intensity of the beam M0 may decrease from the center of the cross-section in form of Hermit-Gaussian.

The intensities of the 1^{st} order OAM mode beam M1 and the 2^{nd} order OAM mode beam M2 may be relatively weak at the center of the cross-section of the beams. The intensities of the beams M1 and M2 may vary from the center of the cross-section in form of Laguerre-Gaussian. For example, the 1^{st} order mode OAM beam M1 may have the strongest intensity at a point departed by r1 from the center of the cross-section. Also, the 2^{nd} order mode OAM beam M2 may have the strongest intensity at a point departed by r2 from the center of the cross-section. Since the divergence angle of the beam M2 is larger than that of the beam Ml, r2 may be larger than r1.

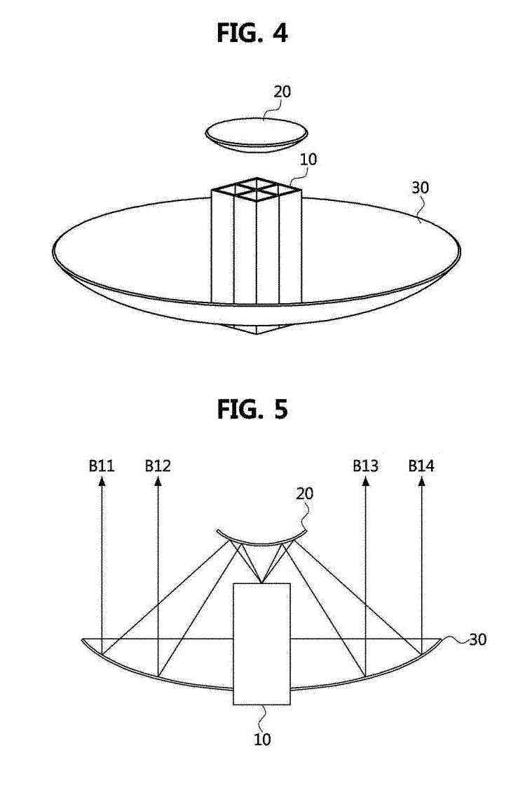

FIG. 4 is a perspective view of a conventional Cassegrain-type antenna radiating a rotational mode beam.

Referring to FIG. 4, the Cassegrain-type antenna may include a radiator 10 composed of 2×2 emitters for emitting beams, a sub-reflector 20 for reflecting the beams emitted from the radiator 10, and a main-reflector 30 for reflecting the beams reflected from the sub-reflector 20. The sub-reflector 20 may have a convex curved shape in a direction facing the main-reflector 30. The vertex of the sub-reflector 20 may be formed in a direction toward the main-reflector 30. The main-reflector 30 may have a convex curved surface shape in a direction opposite to the direction facing the sub-reflector 20. The radiator 10 may be provided at the center of the main-reflector 30. The radiator 10 may emit beams having zeroth order, 1^{st} order, and -1^{st} order OAM modes with the 2×2 emitters.

FIG. 5 is a conceptual diagram illustrating that the antenna shown in FIG. 4 emits zeroth order OAM mode beam rays. FIG. 5 shows that the zeroth order mode OAM beam rays are emitted using a cross-sectional view of the antenna shown in FIG. 4. When radiating the zeroth order OAM mode beam, electromagnetic waves emitted by the respective emitters in the radiator 10 have the same phase so that all of the beam rays are radiated as if they were emitted from the center of the radiator.

Referring to FIG. 5, in case of the conventional Cassegrain-type antenna, when the radiator 10 emits the zeroth order OAM mode beam, rays B11, B12, B13, and B14 may be configured so that their effective emission origins become coincident with a focal point of the sub-reflector 20, and thus traveling directions of the rays B11, B12, B13, and B14 may become almost the same. Also, since the traveling directions of the rays B11, B12, B13, and B14 are almost the same, intervals between the rays B11, B12, B13, and B14 may not be changed as traveling distances of the rays B11, B12, B13, and B14 increase. In the case of the zeroth-order OAM mode beam, since the traveling directions of the rays B11, B12, B13, and B14 are almost the same, the antenna gain is large and the reception intensities of the zeroth order OAM mode beam at the receiving end may be relatively large.

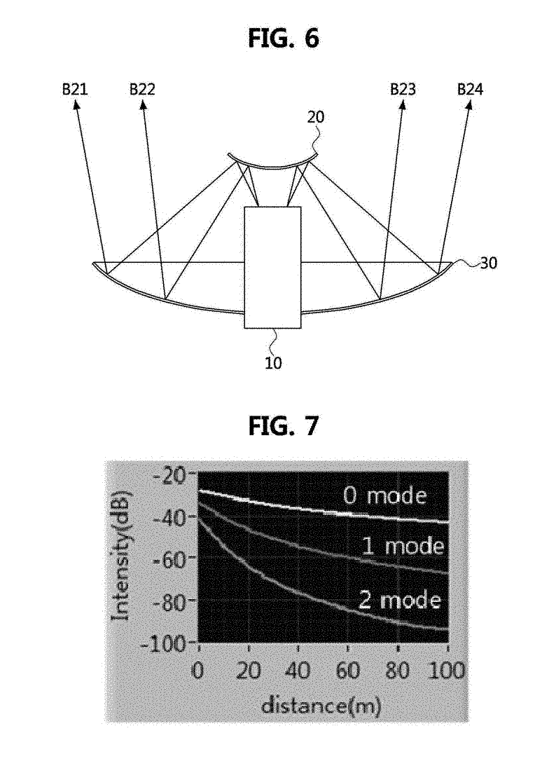

FIG. 6 is a conceptual diagram illustrating that the antenna shown in FIG. 4 emits 1st order OAM mode beams. FIG. 6 shows that the 1^{st} order OAM mode beam rays are emitted using a cross-sectional view of the antenna shown in FIG. 4. When radiating the 1^{st} order OAM mode beam, electromagnetic waves emitted by the respective emitters in the radiator 10 may have phase differences of +90 degrees or −90 degrees so that beam rays are radiated as if they were emitted from different positions of the radiator.

Referring to FIG. 6, if the radiator 10 emits the 1^{st} order mode beam, effective emission origins of the rays B21, B22, B23, and B24 may not coincide with the focal point of the sub-reflector 20, the traveling directions of the beams B21, B22, B23, and B24 may become different from each other, and intervals between the beams B21, B22, B23, and B24 may become larger as traveling distances of the beams B21, B22, B23, and B24 increase. Thus, in the case of the 1^{st} order OAM mode beam, the antenna gain is low and the reception intensities of the 1^{st} order OAM mode beams at the receiving end may be relatively low.

FIG. 7 is a graph illustrating transmission losses according to OAM modes of beams emitted from the conventional antenna. In FIG. 7, the x-axis denotes the traveling distance of the beams, and the y-axis denotes the reception intensities of the beams.

Referring to FIG. 7, in the case of the zeroth order OAM mode beam, a reception intensity reduction of the beam according to the traveling distance may be smaller than that of the higher order OAM mode beams. On the other hand, the 1^{st} order mode beam and the 2^{nd} order mode beam may have a larger reception intensity reduction according to the traveling distance of the beams compared to the zeroth order OAM mode beam. The reception intensity reduction of the beam may be larger as the OAM mode order of the beam is larger. It may not be easy for the receiving end to recover each individual beam from a multiplexed beam if the difference between the reception intensities according to the OAM mode orders of the beams at the receiving end becomes larger than an allowable critical range. Also, as the reception intensities of the higher order mode beams become weaker, the SNR of the higher order mode beams decreases, and it may not be easy for the receiving end to recover the data. Therefore, it is necessary to reduce the transmission loss difference according to the OAM mode orders of the beams. Also, it is necessary to increase the SNR of the higher-order mode beams by reducing the transmission losses of the higher-order mode beams.

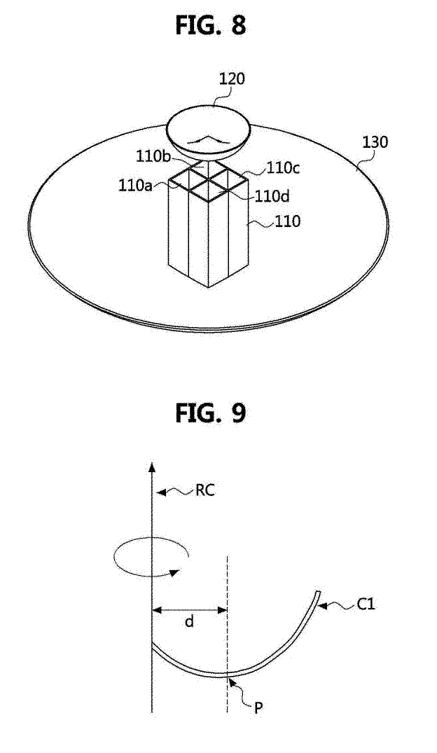

FIG. 8 is a perspective view of an antenna according to a first embodiment of the present disclosure.

Referring to FIG. 8, an antenna may include a radiator 110 for emitting beams. The radiator 110 may include a plurality of emitters 110a, 110b, 110c, and 110d. The OAMs of the beams emitted by the radiator 110 may be determined by phase differences between the beams emitted by the plurality of emitters 110a, 110b, 110c, and 110d. For example, when the radiator 110 emits zeroth order OAM mode beams, the emitters 110a, 110b, 110c, and 110d may emit beams in the same phase. As another example, when the radiator 110 emits 1^{st} order mode beams, the emitters 110a, 110b, 110c, and 110d may emit beams in different phases. The phase of the beam emitted by the second emitter 110b and the phase of the beam emitted by the first emitter 110a may differ by (±π/2). The phase of the beam emitted by the third emitter 110c and the phase of the beam emitted by the first emitter 110a may differ by (±π). The phase of the beam emitted by the fourth emitter 110d and the phase of the beam emitted by the first emitter 110a may differ by (±3/2π). The beams emitted from the radiator 110 may be reflected by the sub-reflector 120. The beam reflected by the sub-reflector 120 may be reflected at the main-reflector 130.

FIG. 9 is a conceptual diagram illustrating a reflective surface shape of the sub-reflector shown in FIG. 8.

Referring to FIG. 9, the reflective surface of the sub-reflector 120 may have a shape of a trace formed by rotating a curve C1 including one vertex P around a rotation axis RC. The vertex P of the curve C1 and the rotation axis RC may be spaced apart from each other. That is, the distance d between the vertex P of the curve C1 and the rotation axis RC may be greater than zero. The distance d may vary depending on a distance between the radiator 110 and the sub-reflector 120 and a distance between the sub-reflector 120 and the main-reflector 130. The curve C1 may be convex in the direction facing the main-reflector 130. Thus, the reflective surface of the sub-reflector 120 may include vertices that form a circular trace. The vertices of the circular trace may be formed in a direction toward the main-reflector 130. The reflective surface of the sub-reflector 120 may further include one vertex provided on the rotation axis RC. The vertex provided on the rotation axis RC may be formed in a direction opposite to the direction toward the main-reflector 130.

The curve C1 may be a convex curve in the direction toward the main-reflector 130. One end of the curve C1 may meet with the rotation axis RC. The curve C1 may include one vertex P formed in the direction toward the main-reflector 130. Illustratively, the curve C1 may be part of a hyperbola.

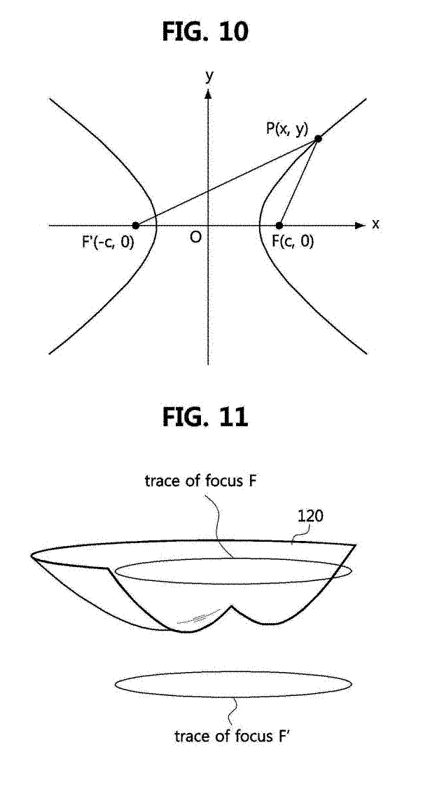

FIG. 10 is a graph illustrating an example of a hyperbola.

Referring to FIG. 10, a hyperbola may be a set of points P(x,y) having the same distance from two points F and F′. The focal points of the hyperbola may correspond to the two points F and F′. The focal points of the hyperbola and the vertexes of the hyperbola may be on the axis of symmetry (i.e., x axis) of the hyperbola. The reflective surface of the sub-reflector 120 may have a shape of a trace formed by rotating a part of the hyperbola. The reflective surface of the sub-reflector 120 may have a shape of a trace formed by rotating a part of the hyperbola around a rotation axis spaced apart from the axis of symmetry (i.e., x axis) of the hyperbola.

FIG. 11 is a perspective view showing a cross-section of the sub-reflector shown in FIG. 8.

Referring to FIG. 11, the cross-section of the sub-reflector 120 may be a form in which two curves are connected symmetrically. The vertexes of the two curves may be formed in a direction toward the main-reflector 130. The two curves may be a part of a hyperbola. Thus, the focal points (focuses) of the reflective surface of the sub-reflector 120 may form circular traces. As shown in FIG. 10, the hyperbola may be defined by the two focal points F and F′. As shown in FIG. 11, when the part of the hyperbola is rotated, the focal point F in FIG. 10 may have the trace formed in the inside of the reflective surface, and the focal point F′ in FIG. 10 may have the trace formed in the outside of the reflective surface.

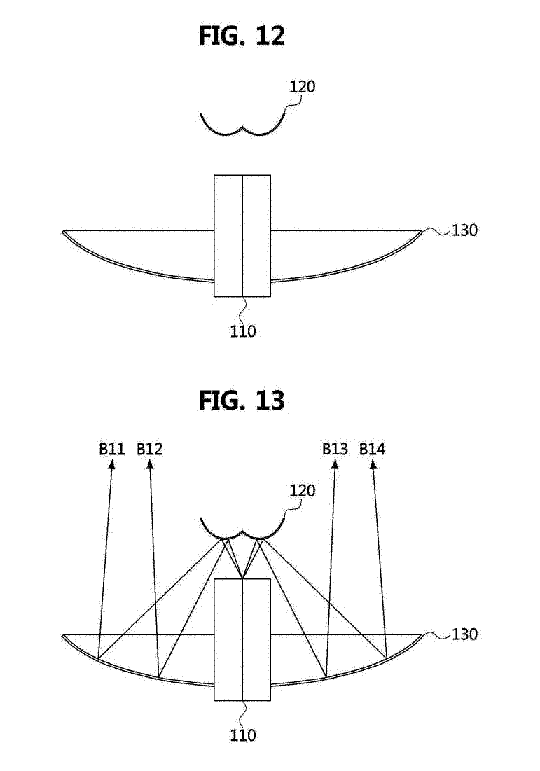

FIG. 12 is a cross-sectional view of the antenna shown in FIG. 8. The cross-sectional view of FIG. 12 is a cross-sectional view in the y-z plane direction of FIG. 8.

Referring to FIG. 12, the radiator 110 may emit beams toward the sub-reflector 120. The cross-section of the sub-reflector 120 may have a shape in which two curves are symmetrically connected. The output center of each emitter may coincide with the trace of the outer focal point of the sub-reflector. In FIG. 12, a case where the upper part of the reflective surface of the sub-reflector 120 is empty is shown as an example, but the embodiment is not limited thereto. The reflective surface of the sub-reflector 120 may have a shape of a trajectory in which a curve is rotated, and the upper part of the reflective surface of the sub-reflector 120 may be empty or filled.

The vertex of the curve may be formed in the direction toward the radiator 110 and the main-reflector 130. A single vertex may be formed at the center of the reflective surface of the sub-reflector 120.

FIG. 13 is a conceptual diagram illustrating traveling directions of beam rays when the radiator 110 emits the zeroth order mode beams.

Referring to FIG. 13, the beam rays emitted from the radiator 110 may be reflected by the sub-reflector 120 and then reflected by the main-reflector 130. Differently from the case illustrated in FIG. 5, the shape of the reflective surface of the sub-reflector 120 is changed so that the output center of the radiator 110 and the focal point of the sub-reflector 120 do not coincide with each other and the traveling directions of the beam rays B11, B12, B13, and B14 may be different from those of FIG. 5. The traveling directions of the zeroth order mode beam rays B11, B12, B13, and B14 may be changed according to their reflection positions on the sub-reflector 120. The zeroth order mode beam rays B11, B12, B13, and B14 may not be propagated in the same direction after being reflected by the main-reflector 130. Therefore, the intervals between the beam rays B11, B12, B13 and B14 may become larger as the traveling distances of the beam rays B11, B12, B13 and B14 increase.

In the case that the reflective surface of the sub-reflector 120 is designed as illustrated in FIG. 13, when the radiator 110 emits the zeroth order mode beams, the transmission loss depending on the traveling distances of the beams may be larger than the conventional one. That is, the antenna gain according to the embodiment of the present disclosure may be lower than that of the conventional antenna.

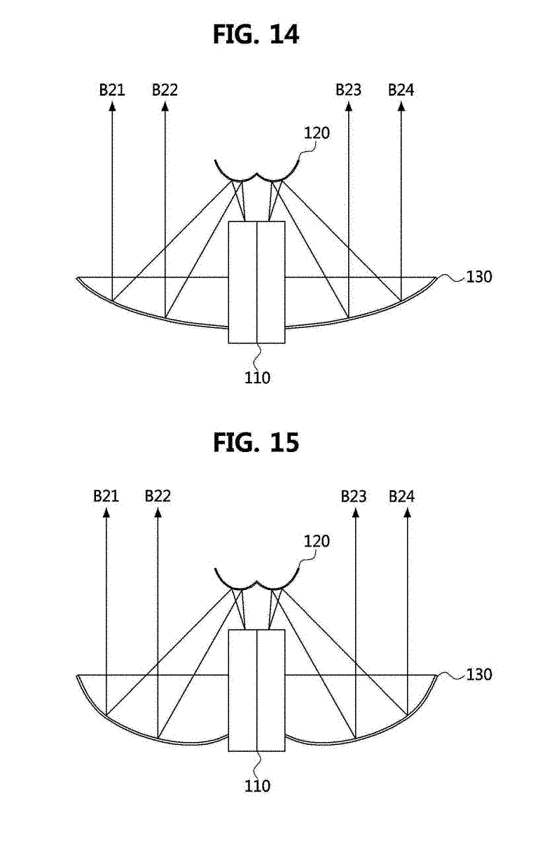

FIG. 14 is a conceptual diagram illustrating traveling directions of beam rays when the radiator 110 emits the 1^{st} order mode beams.

Referring to FIG. 14, the beams emitted from the radiator 110 may be reflected by the sub-reflector 120 and then reflected by the main-reflector 130. Differently from the case illustrated in FIG. 6, the shape of the reflective surface of the sub-reflector 120 is changed so that the output center of the radiator 110 and the focal point of the sub-reflector 120 coincide with each other and the traveling directions of the beam rays B11, B12, B13, and B14 may be almost the same. Therefore, even if the traveling distances of the beams B21, B22, B23, and B24 increase, the intervals between the beams B21, B22, B23, and B24 may be almost unchanged.

Since the traveling directions of the 1^{st} order mode beams B21, B22, B23 and B24 are almost the same, the transmission loss according to the traveling directions of the 1^{st} order mode beams B21, B22, B23, and B24 may be smaller than the transmission loss according to the traveling distances of the zeroth order beams B11, B12, B13, and B14 shown in FIG. 13. Therefore, it is made possible to compensate for the difference between transmission losses caused by the divergence angles of the zeroth order mode and the 1^{st} order mode. That is, it is possible to prevent the reception intensities of the 1^{st} order mode beams from becoming excessively small as compared with the reception intensities of the zeroth order mode beams. Also, the SNR of the 1^{st} order mode beams can be increased. Although the 1^{st} order mode beams have been illustrated by way of example in FIG. 14, the same principles may be applied to other higher order mode beams. Therefore, the antenna according to the embodiment of the present disclosure can increase the antenna gain of the high-order mode beams over the conventional antenna.

FIG. 15 is a conceptual view illustrating a cross-section of an antenna and traveling directions of higher-order mode beams according to a second embodiment of the present disclosure.

Referring to FIG. 15, the reflective surface of the main-reflector 130 may have a shape of a trace formed by rotating a curve similarly to the reflective surface of the sub-reflector 120. The reflective surface of the main-reflector 130 may have a shape in which a curve is rotated around a rotation axis spaced apart from a vertex of the curve. In this case, the transmission loss of the higher order mode beams can be reduced. Also, the transmission loss of the zeroth order mode beams can be larger than the conventional one.

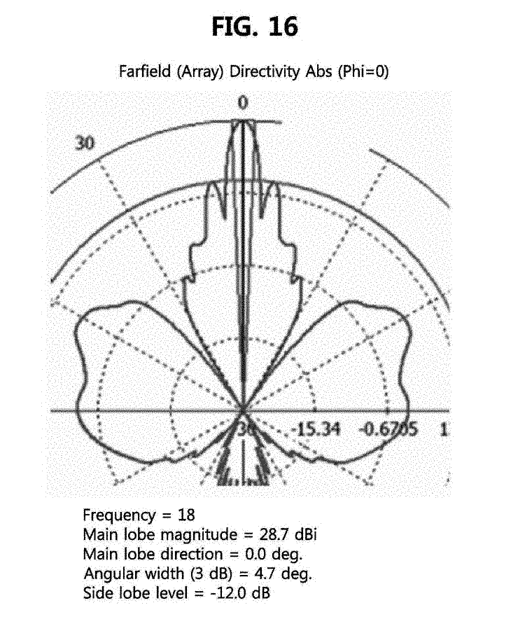

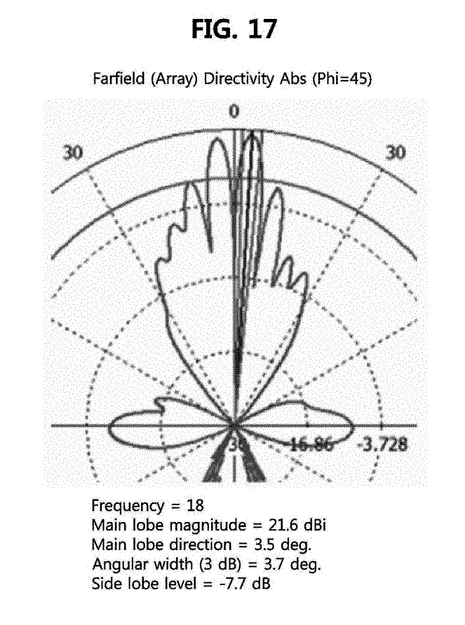

FIG. 16 is a graph illustrating antenna gains when zeroth order mode beams are radiated using the conventional antenna shown in FIG. 4. Referring to FIG. 16, a main lobe gain of the zeroth order mode beam may be 28.7 dB. Also, FIG. 17 is a graph illustrating antenna gains when 1^{st} order mode beams are radiated using the conventional antenna shown in FIG. 4. Referring to FIG. 17, a main lobe gain of the 1^{st} order mode beam may be 21.6 dB.

That is, in the case of the conventional antenna, the main lobe gain difference between the zeroth order mode beam and the 1^{st} order mode beam is 7.1 dB, and it may not be easy to detect the 1^{st} order mode beam separately from the zeroth order mode beam at the receiving end. Also, the SNR of the 1^{st} order mode beam may be small.

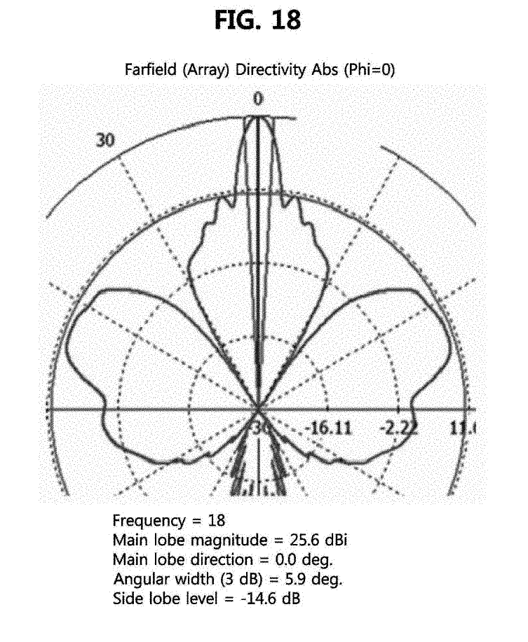

FIG. 18 is a graph illustrating antenna gains when zeroth order mode beam is radiated using the antenna described referring to FIGS. 8 to 15. Referring to FIG. 18, a main lobe gain of the zeroth order mode beam may be 25.6 dB. That is, using the antenna according to the embodiment of the present disclosure, the transmission gain of the zeroth order mode beam can be reduced as compared to the conventional antenna.

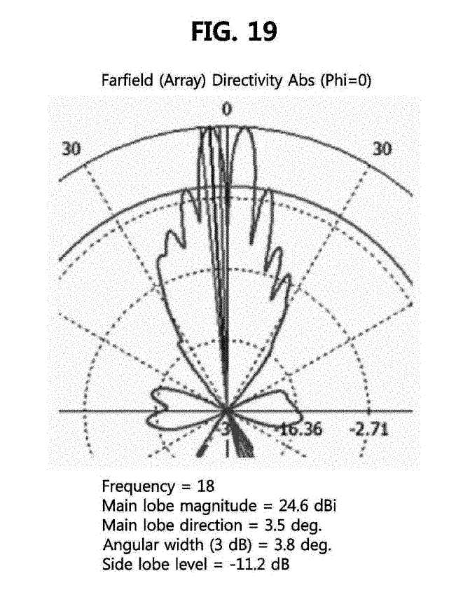

FIG. 19 is a graph illustrating antenna gains when 1^{st} order mode beams are radiated using the antenna described referring to FIGS. 8 to 15. Referring to FIG. 19, a main lobe gain of the 1^{st} order mode beam may be 24.6 dB. Using the antenna according to the embodiment of the present disclosure, a main lobe gain difference between the zeroth order mode beam and the 1^{st} order mode beam may become 1.0 dB which is reduced by 6.1 dB from the conventional one (i.e., 7.1 dB). Therefore, it is easy to separate the 1^{st} order mode beam from the zeroth order mode beam and detect it at the receiving end. Also, the SNR of the 1st order mode beam can be increased.

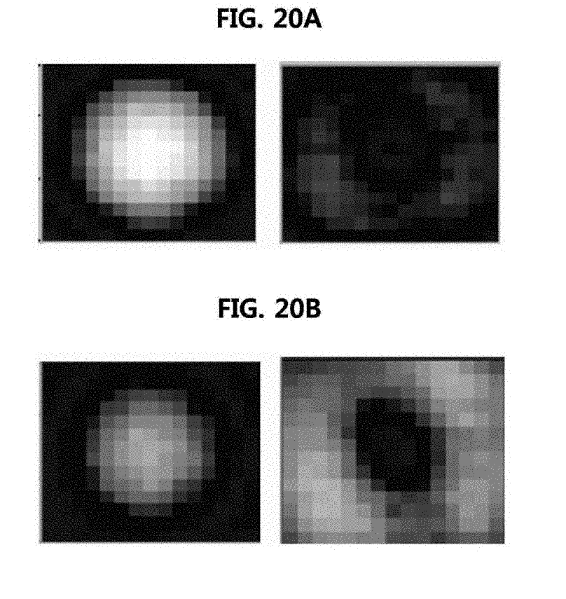

FIGS. 20A and 20B are diagrams illustrating results of comparison between electromagnetic field intensities of beams radiated respectively from the conventional antenna and the antenna according to the embodiment of the present disclosure. The measurement result shown in FIG. 20 may be a result of measuring the beams at 2 meters ahead of the respective antennas.

FIG. 20A illustrates a result of comparison between electromagnetic field intensities of beams radiated from the conventional antenna. In FIG. 20A, the left side shows the intensity of the electromagnetic field when the zeroth order mode beams are radiated from the conventional antenna, and the right side shows the intensity of the electric field when the 1^{st} order mode beams are radiated from the conventional antenna. The intensity of the electromagnetic field is proportional to the brightness in the image.

FIG. 20B illustrates a result of comparison between electromagnetic field intensities of beams radiated from the antenna according to the embodiment of the present disclosure. In FIG. 20B, the left side shows the intensity of the electromagnetic field when the zeroth order mode beams are radiated from the antenna according to the embodiment of the present disclosure, and the right side shows the intensity of the electromagnetic field when the 1^{st} order mode beams are radiated from the antenna according to the embodiment of the present disclosure. The intensity of the electric field is proportional to the brightness in the image.

When the transmission power of the antenna is 0 dBm (i.e., corresponding to 1 mW), the intensity of the zeroth order mode beams and the intensity of the 1^{st} order mode beams of the conventional antenna are −32.5 dBm and −38.6 dBm, respectively. As compared to the 1^{st} order mode beam, the zeroth order mode is measured to be 6.1 dB higher. However, as a result of changing the shape of the sub-reflector according to the embodiment of the present disclosure, the main lobe intensities of the zeroth order mode beams and the 1^{st} order mode beams are −35.5 dBm and −34.5 dBm, respectively. That is, as compared to the zeroth order mode beam, the 1^{st} order mode is measured to be 1 dB higher.

Hereinabove, the antennas according to the embodiments of the present disclosure and signal transmission method for the same have been described with reference to FIGS. 1 to 20. Using to the embodiments according to the present disclosure, it is made possible to easily detect a beam having a specific OAM at the receiving end by reducing differences of transmission losses or transmission gains between the zeroth order mode beam and the higher order mode beams. Also, by reducing the transmission loss of the higher order mode beams, the signal-to-noise ratio (SNR) of the higher order mode beams can be increased.

While the embodiments of the present disclosure and their advantages have been described in detail, it should be understood that various changes, substitutions and alterations may be made herein without departing from the scope of the present disclosure.

What is claimed is:

1. A Cassegrain-type antenna comprising:
a main-reflector;
a sub-reflector; and
a radiator radiating beams by using a plurality of emitters,
wherein a reflective surface of the sub-reflector has a shape of a trace formed by rotating a first curve having a vertex and being convex toward the main-reflector around a rotation axis spaced apart from the vertex.

2. The Cassegrain-type antenna according to claim 1, wherein the rotation axis meets one end of the first curve.

3. The Cassegrain-type antenna according to claim 1, wherein the reflective surface of the sub-reflector includes vertexes forming a circular trace.

4. The Cassegrain-type antenna according to claim 3, wherein the reflective surface of the sub-reflector further includes a vertex formed in a direction opposite to a direction facing the main-reflector.

5. The Cassegrain-type antenna according to claim 1, wherein the reflective surface of the sub-reflector has a shape of a trace formed by rotating at least a part of a hyperbola.

6. The Cassegrain-type antenna according to claim 1, wherein focal points of the reflective surface of the sub-reflector form a circular trace.

7. The Cassegrain-type antenna according to claim 1, wherein a reflective surface of the main-reflector has a shape convex in a direction opposite to a direction facing the sub-reflector.

8. The Cassegrain-type antenna according to claim 1, wherein a reflective surface of the main-reflector has a shape of a trace formed by rotating a second curve having a vertex around a rotation axis spaced apart from the vertex of the second curve.

9. The Cassegrain-type antenna according to claim 8, wherein the second curve is convex in a direction opposite to a direction toward the sub-reflector.

10. The Cassegrain-type antenna according to claim 8, wherein the reflective surface of the main-reflector includes vertexes forming a circular trace.

11. The Cassegrain-type antenna according to claim 1, wherein the beams radiated by the radiator are reflected by the sub-reflector, and then reflected by the main-reflector, and antenna gains of the beams reflected by the main-reflector are changed according to respective orbital angular momentums (OAMs) of the beams.

12. The Cassegrain-type antenna according to claim 11, wherein antenna gains of zeroth order OAM mode beams among the beams are less than antenna gains of 1^{st} order OAM mode beams among the beams.
